(19) United States
(12) Patent Application Publication
(10) Pub. No.: US 2011/0183107 A1
(43) Pub. Date: Jul. 28, 2011

(54) DENTAL MIRROR PROTECTIVE COVER

(76) Inventor: Marie Wickman-Dykes, Council Bluffs, IA (US)

(21) Appl. No.: 12/536,199

(22) Filed: Aug. 5, 2009

Related U.S. Application Data
(60) Provisional application No. 61/188,012, filed on Aug. 5, 2008.

(51) Int. Cl. B32B 3/10

(52) U.S. Cl. 428/131

(57) ABSTRACT

A protective cover includes a first side having a plurality of openings, a second side having a plurality of openings, and an interior portion coupling the first side to the second side. The first side, the second side, and the interior portion define a cavity configured to receive a medical instrument and the protective cover is flexible. The cavity is configured to be in fluid communication with a region exterior to the cover to facilitate cleaning of a dental or other medical instrument placed in the cover.

### CROSS REFERENCE TO RELATED APPLICATION

This application is a non-provisional of U.S. Application Ser. No. 61/188,012 filed on Aug. 5, 2008, titled DENTAL MIRROR PROTECTIVE COVERS which is incorporated by reference herein in its entirety.

### BACKGROUND OF THE INVENTION

In the dental or medical field, it is required by law to use sterile instruments. These instruments are cleaned in large numbers for mass cleaning in an ultrasonic process, which is a large tub of a disinfectant solution that uses sound waves to remove any debris off the instruments. Then placed with other dental instruments in a sterilization bag in large groups based on specific dental procedures to then be sterilized, thus causing the mirror to endure scratching and surface damage from the instrument they are packaged with.

### BRIEF SUMMARY OF THE INVENTION

A protective cover includes a first side having a plurality of openings, a second side having a plurality of openings, and an interior portion coupling the first side to the second side. The first side, the second side, and the interior portion define a cavity configured to receive a medical instrument and the protective cover is flexible. The cavity is configured to be in fluid communication with a region exterior to the cover to facilitate cleaning of a dental or other medical instrument placed in the cover.

### BRIEF DESCRIPTION OF THE SEVERAL VIEWS OF THE DRAWINGS

FIG. 1 is a side elevation view of a protective cover.

FIG. 2 is another side elevation view of a protective cover.

FIG. 3 is a side elevation view of a protective cover placed on a dental mirror.

FIG. 4 is a perspective view of a protective cover.

FIG. 5 is an elevation view of a protective cover.

FIG. 6 is a crossectional view of the protective cover of FIG. 5 taken along line 6-6.

### DETAILED DESCRIPTION OF THE INVENTION

The solution in preventing the dental mirror from being scratched is to place a removable silicone rubber protective covering over the mirror during cleaning and handling of the instruments. The silicone cover would be designed with holes on the surface to allow cleaning solution as well as debris to wash away after sterilizing.

Silicone is ideal for protection because of its flexible texture, and heat/chemical resistant make-up. Once you are done with any procedure, you would apply by simply stretching the cover around the head of the dental mirror, you can then safely gather your instruments and place in the ultrasonic, rinse and put in a sterilization bag to sterilize. Then when needed, you can open the bag, take out the instruments, remove your protective cover before you begin and have a scratch-free mirror.

This product will be less expensive then replacing the mirror heads making it more cost effective. This silicone cover would be marketed in bulk for an affordable solution. In addition, they will come in a variety of colors to help identify specific dental instruments.

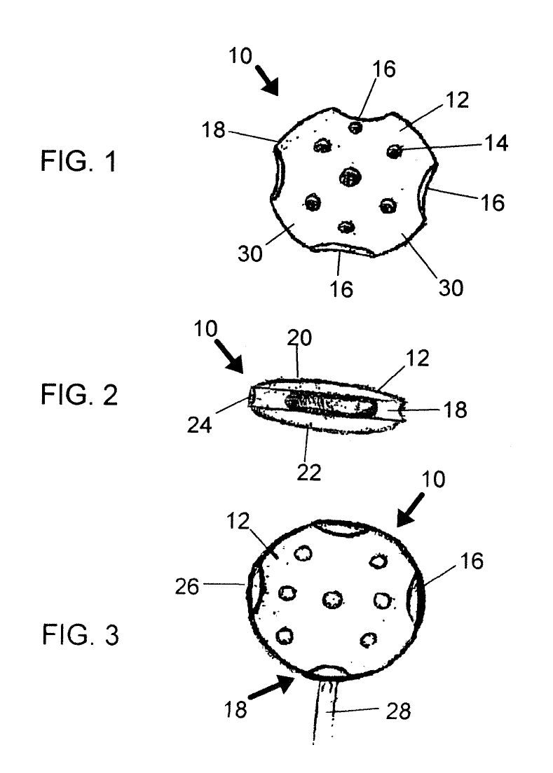

Referring to FIGS. 1-3, a dental mirror cover 10 comprises a silicone cover having a first side 20, a second side 22, and a middle or interior portion 24. The three portions may be fabricated separately and assembled by ultrasonic welding, adhesives or other suitable method. Alternatively, the cover 12 may be fabricated as a singly unit by injection molding or other method.

Each of sides 20 and 22 have a plurality of openings 14 that extend from an outer surface of the sides to a cavity. Openings 14 thus put the cavity in fluid communication with a region external to the cover 12. Cover 12 further includes side openings 16 along an edge of cover 12. Side openings provide an area through which a portion of a dental mirror 26 may protrude. This allows cover regions 30 to extend around dental mirror 26 and secure cover 12 to dental mirror 26 such that cover 12 does not fall off of dental mirror 26 during washing. The flexible nature of the material used for cover 12 allows a user to remove cover 12 from dental mirror 26. Alternatively, cover 12 could be manufactured as a “clam shell design” to allow sides 20 and 22 to be clamped over mirror 26.

Cover 12 is shown having three side openings 16 and one mirror opening 18. Mirror opening 18 is configured to be large enough for the head of a dental instrument such as mirror 26 to be received into the cavity. Alternatively, all side openings may be configured in this manner to make application of the cover easier for a user.

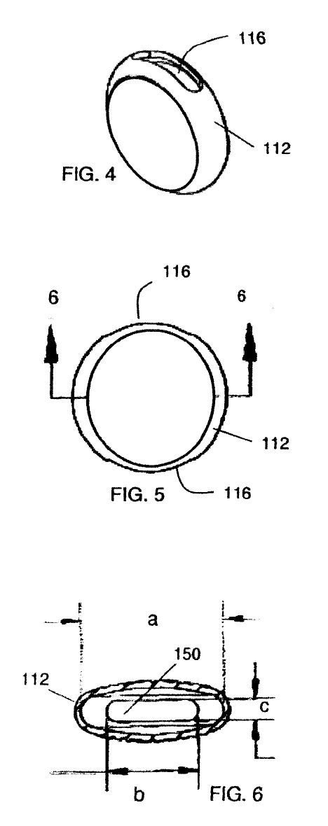

Referring to FIGS. 4-6, a cover 112 may be configured with only two openings 116. These openings may be configured such that a dental instrument such as a mirror may be inserted through either of openings 116. Also, if the material selected is sufficiently flexible, cover 112 may be provided with a passage 150 which extends from one side of cover 112 to an opposing side and has a substantially constant crossectional diameter. Further, covers may be manufactured in a variety of sizes to accommodate different dental tools. For example, common sizes of mirrors may be used with a cover having dimensions of a=0.974 in., b=0.630 in., and c—0.142 in. Another common size of mirror may be used with a cover having dimensions of a=1.142, b=0.750 in., and c=0.142 in. However, covers of other sizes and configuration could also be used. The described covers may be used without side openings (shown as openings 14 in FIG. 1) while still providing sufficient fluid communication between passage 150 and a region external to cover 112 to allow for the sufficient cleaning of a dental tool.

Not only would this silicone rubber protective covering be used for dental mirrors but also for medical mirrors, industrial and beauty mirrors and other washable, reusable tools that are sensitive to scratching.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Further, as used herein the term “plurality” refers to at least two elements. Additionally, like numbers refer to like elements throughout.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow. The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A protective cover comprising:
a first side having;
a second side having;
an interior portion coupling the first side to the second side; and
a plurality of side openings;
wherein the first side, the second side, and the interior portion define a cavity configured to receive a medical instrument and the protective cover is flexible.

2. The protective cover of claim 1, wherein the protective cover comprises a silicone compound.

3. The protective cover of claim 1, wherein the first side, the second side, and the interior portion are formed as a single unitary body.

4. The protective cover of claim 3, wherein the cover is formed by injection molding.

5. The protective cover of claim 1, wherein the cover comprises a material that is stable at temperatures required for washing medical instruments.

6. The protective covering of claim 1 wherein each of the first side and the second side comprise a plurality of openings.
